(19) United States
(12) Patent Application Publication
(10) Pub. No.: US 2013/0153333 A1
(43) Pub. Date: Jun. 20, 2013

(54) Safety device for an aerial lift, a method of operation thereof, an aerial lift having the safety device, a kit of parts and a method of installation thereof for providing the safety device in an aerial lift

(71) Applicant: Paul Richards, Oxford (GB)

(72) Inventor: Paul Richards, Oxford (GB)

(21) Appl. No.: 13/689,116

(22) Filed: Nov. 29, 2012

(30) Foreign Application Priority Data
Dec. 15, 2011 (GB) 1121586.0

(51) Int. Cl. B66F 11/04

(52) U.S. Cl. CPC B66F 11/04
USPC 182/18; 182/129; 182/113; 29/700

(57) ABSTRACT

An aerial lift, a kit of parts for installing a safety device in the aerial lift and a method includes a moveable platform having a control panel operable to manoeuvre the platform provided near a first side of the platform and a proximity sensing means that remotely senses the presence of off-platform objects within a sensing zone opposite the control panel. A further method averts an accident when operating an aerial lift by remotely sensing whether or not an off-platform object is present in a sensing zone of proximity, and if an object is sensed in the sensing zone, signalling an alarm and/or shutting down the aerial lift to stop further movement of the platform.

### TECHNICAL FIELD

The present invention relates to safety devices for aerial lifts, in particular aerial lifts having a moveable platform having a control panel operable to manoeuvre the platform.

### BACKGROUND TO THE INVENTION

Aerial lifts having moveable platforms have become commonly used to manoeuvre equipment or personnel on the platforms to elevated locations, for example, for performing construction, maintenance or inspection work, for instance, in the buildings and estates sector.

Aerial lifts typically comprise a moveable platform located at one end of an articulated and telescopic boom, at the other end of which is a stabilised base that may itself be moveable by way of steerable wheels or caterpillar tracks. By way of operation of a control panel provided on one side of the platform, an operator of the aerial lift stationed on the platform can cause the platform to be raised, lowered, rotated and otherwise moved by sending control signals to a powered hydraulic system for manipulating the boom relative to the base unit, and can also cause the base unit to be moved forwards and backwards, and steered or rotated, by sending control signals to a powered drive unit for providing torque to the wheels/caterpillar tracks and steering system.

While an operator is in an elevated position, the range of movement achievable using these aerial lifts can easily result in the operator becoming disorientated, and the work that the operator is attending to can lead to the operator becoming distracted, such that hazards nearby the platform are not noticed. As such, the operation of these aerial lifts can represent a dangerous activity, although the occurrence of accidents can be mitigated by proper training of operators.

Nevertheless, a safety device known as a ‘dead man's switch’ is commonly provided to reduce the likelihood of accidents occurring or to reduce the severity of accidents that do occur. The dead man's switch is provided as a foot pedal adjacent the control panel that must be depressed by the operator in order to close a switching circuit that when open, disables movement of the aerial lift. This dead man's switch is intended not only to direct the operator to check for any hazards before manoeuvring the platform, but also to indirectly cause any movement of the platform to be immediately ceased should the operator be knocked away from the control panel during use by, for example, accidental collision of the operator or the boom with a hazard, such as an off-platform obstruction like a beam, buttress or bulkhead.

However, this dead man's switch has a vulnerability that can occur when the movement of the platform relative to an off-platform object is such that a collision with that object causes the operator to be knocked onto the control panel while maintaining the closed state of the dead man's switch. For example, an operator moving the platform backwards without looking in the direction to travel cannot see any hazards that could knock the operator forwards onto the control panel if the operator were to collide with that hazard. This kind of accident could have the catastrophic effect that the operator may be knocked unconscious onto the control panel which may cause the movement of the platform towards the hazard to be continued, resulting in the operator being crushed against the hazard and suffering severe injury or death.

There is therefore an ongoing need in the art to improve the safety of equipment such as aerial lifts.

European patent application number EP 2 096 078 A discloses a safety device intended to address this specific problem by providing a trip wire across the control panel that is connected to a switching circuit and which is configured to deactivate the control panel and discontinue movement of the platform should the trip wire become distorted, for example, due to the operator being knocked against the control panel.

It is also known to build up a protective structure at the sides of the platforms of aerial lifts, the protective structure being arranged with the intention that it should collide first with any encroaching hazards, to attempt to avoid initial collision with an operator of the aerial lift.

### SUMMARY OF THE INVENTION

Viewed from one aspect the present invention provides a safety device for an aerial lift comprising a moveable platform having a control panel operable to manoeuvre the platform provided near a first side of the platform; the safety device comprising: proximity sensing means arranged to, in use, remotely sense the presence of off-platform objects within a sensing zone opposite the control panel.

In accordance with the present invention, the provision of proximity sensing means to remotely sense the presence of off-platform objects within a sensing zone opposite the control panel is usable to detect the presence of hazardous objects that the operator of an aerial lift may not be aware of during use. This detection can be used, for example, to signal an alarm to the operator and/or to deactivate the movement of the platform before an accident such as a collision can even occur. This is contrasted with the protective structure, trip wire and dead man's switch safety devices which only become effective after a collision has occurred, which in many cases may be too late to avert an accident that can result in injury, death, damage to the aerial lift or carried equipment, or damage to surrounding property. For example, even with a protective structure and a tripwire, an operator could be struck on the head at speed by collision with a protruding bar, or lacerated by a protruding sharp object. These accidents would be averted using the safety device of the present invention.

In addition, the safety device of the present invention can be easily installed in existing aerial lifts by retrofitting without affecting the loading, capacity and balance of the platform, unlike a retrofitted protective structure that can also inhibit the ability of operators on the platform to conduct their work.

Furthermore, where the safety device of the present invention is communicatively isolated from the control system of the aerial lift and is not configured to automatically deactivate the movement of the platform on detection of an object in a sensing zone, the safety device can be fitted to the aerial lift and used to avert accidents without otherwise interfering with the operation of the aerial lift's other systems, thereby ensuring that safe operation of the lift is maintained. In this case, the safety device of the present invention can be fitted without having to then safety test and approve the operation of the modified aerial lift (such as to ensure the technical requirements necessary to obtain a ‘CE’ mark for the aerial lift are fulfilled). Furthermore, the present invention allows inadvertent triggering of the deactivation of the movement of the platform to be avoided. This is contrasted with the trip wire-type arrangements which are integrated into the control systems of the aerial lift and could require full safety testing and approval before use due to the necessary modification of the aerial lift's control systems to allow the safety device to work, and which could easily be accidentally knocked, for example, by a knee of the operator, causing the unintended deactivation of the control panel. This would be annoying, potentially dangerous, and could lower the efficiency of the use of the aerial lift itself.

In accordance with the present invention, the proximity sensing means is easily adaptable to numbers of different designs and arrangements. This lends itself to a kit of parts than can be retrofitted to a number of different aerial lifts having platforms with differed designs, shapes and sizes. For example, members of various designs arranged to be mounted on a protective rail of different models of aerial lift can be provided and used to accurately position proximity sensing means, such as one or more proximity sensors, about the platform of the aerial lift in order to provide an effective safety device having an accurately positioned sensing zone for that model of aerial lift. In addition, the size and positioning of the sensing area can easily be adapted or adjusted.

The sensing zone is preferably arranged to detect the presence of objects located substantially outside the perimeter of the platform. This is such that the proximity sensing means only detects the presence of objects in the sensing zone substantially outside the platform area, such that on-platform objects (such as operators, equipment and other platform-born load) are not detected and do not, for example, cause the unintended signalling of an alarm or deactivation of the aerial lift's movement.

The proximity sensing means may comprise one or more proximity sensors. The one or more proximity sensors may be supported by a protective rail surrounding the platform. The one or more proximity sensors may be arranged around the protective rail on at least a side of platform opposite the control panel. The one or more proximity sensors may be provided on one or more members mounted to the protective rail. This arrangement may occur, for example, where the safety device has been retrofitted to an aerial lift by way of a kit of parts. As such, the one or more proximity sensors and one or more members may be assembled from a kit of parts that is adapted to be retrofitted to the aerial lift. Alternatively, the one or more proximity sensors may be integrated with the protective rail, which may occur, for example, where the safety device has been provided as a feature of the aerial lift at the time of manufacture of the lift. The one or more proximity sensors may be passive infrared sensors or ultrasonic sensors.

The safety device may further comprise alarm means configured to signal an alarm responsive to the sensing of the presence of an object within the sensing zone by the proximity sensing means. This way, the operator can be alerted to the hazard before a collision occurs, allowing action to be taken by the operator to avert the collision. The alarm means may provide a visual alarm and/or auditory alarm. The proximity sensing means and its corresponding alarm means may be communicatively isolated from a control system of the aerial lift.

Alternatively, the proximity sensing means and its corresponding alarm means may be communicatively coupled with a control system of the aerial lift. For example, the safety device may further comprise shut-down means configured to stop further movement of the platform responsive to the sensing of the presence of an object within the sensing zone by the proximity sensing means in the case where the proximity sensing means and its corresponding alarm means are communicatively coupled with the control system of the aerial lift. In this way, the safety device can automatically prevent a collision from occurring by preventing further movement of the platform where the presence of a hazardous object is sensed.

The alarm means may be configured to signal an alarm responsive to the sensing the presence of an object by the proximity sensing means at a first distance from the platform in the sensing zone, and the shut-down means may be configured to stop further movement of the platform responsive to the sensing of the presence of an object by the proximity sensing means at a second distance from the platform in the sensing zone. The first distance may be greater than the second distance.

The safety device may further comprise an override means operable to deactivate the alarm means and/or the shut-down means and/or the proximity sensing means. In this way, an operator, already made aware of a hazard, for example by the safety device, can choose to deactivate the safety device while continuing to manoeuvre the platform (for example, to silence the alarm or to prevent deactivation of the platform's movement by the safety device).

The nominal range of the sensing zone is preferably 5 meters from the platform, more preferably 3 meters from the platform, still more preferably 2 meters from the platform.

Viewed from a second aspect, the present invention provides an aerial lift comprising: a moveable platform comprising a control panel operable to manoeuvre the platform provided near a first side of the platform; a foot switch located adjacent to the control panel configured to enable the movement of the platform only when the foot switch is closed; and a proximity-detecting safety device as recited above.

Viewed from a third aspect, the present invention provides a method for providing a safety device in an aerial lift having a moveable platform having a control panel operable to manoeuvre the platform provided near a first side of the platform, the method comprising: providing proximity sensing means on the platform and arranging the proximity sensing means to, in use, remotely sense the presence of off-platform objects within a sensing zone opposite the control panel.

The proximity sensing means may comprise one or more proximity sensors and wherein providing and arranging the proximity sensing means comprises providing the one or more proximity sensors to be supported by the platform and locating the proximity sensors in positions to provide a sensing zone opposite the control panel.

The proximity sensing means may comprise one or more proximity sensors arranged on one or more members configured to be mounted about a protective rail surrounding the platform and wherein providing and arranging the proximity sensing means comprises mounting the one or more means about the protective rail.

The method may further comprise installing a proximity sensor control module at the control panel and communicatively coupling the proximity sensor control module to the proximity sensing means. The proximity sensor control module may comprise one or more of: alarm means configured to signal an alarm responsive to the sensing of the presence of an object within the sensing zone by the proximity sensing means: shut-down means configured to stop further movement of the platform responsive to the sensing of the presence of an object within the sensing zone by the proximity sensing means; and an override means operable to deactivate the alarm means and/or the shut-down means and/or the proximity sensing means.

Viewed from a fourth aspect, the present invention provides a method of averting an accident when operating an aerial lift comprising a moveable platform having a control panel operable to manoeuvre the platform provided near a first side of the platform, the method comprising: remotely sensing whether or not an off-platform object is present in a sensing zone of proximity sensing means arranged to remotely sense the presence of off-platform objects within a sensing zone opposite the control panel; and if an object is sensed in the sensing zone, signalling an alarm and/or shutting down the aerial lift to stop further movement of the platform.

Viewed from a fifth aspect, the present invention provides a kit of parts for installing a safety device in an aerial lift, comprising: one or more proximity sensors; and one or more members adapted to be mounted to a platform of an aerial lift and to receive and support said one or more proximity sensors such that, in use, the one or more proximity sensors are arranged to remotely sense the presence of off-platform objects within a sensing zone opposite a control panel provided on a moveable platform of the aerial lift.

The kit of parts may further comprise a proximity sensor control module configured to be installed in the control panel and to be communicatively coupled in use to the one or more proximity sensors. The proximity sensor control module may comprise one or more of: alarm means configured to signal an alarm responsive to the sensing of the presence of an object within the sensing zone by the one or more proximity sensors; shut-down means configured to stop further movement of the platform responsive to the sensing of the presence of an object within the sensing zone by the one or more proximity sensors; and override means operable to deactivate the alarm means and/or the shut-down means and/or the one or more proximity sensors.

### BRIEF DESCRIPTION OF THE DRAWINGS

Certain preferred embodiments of aspects of the present invention will now be described by way of example only with reference to the accompanying drawings, in which:

FIG. 1 shows a view of an aerial lift incorporating a safety device in accordance with an embodiment of the present invention;

FIG. 2 shows a detailed view of the platform of the aerial lift shown in FIG. 1;

FIG. 3 shows a schematic representation of a safety device in accordance with an embodiment of the present invention; and

FIG. 4 shows a process flow diagram for operating a safety device in accordance with an embodiment of the present invention.

### DESCRIPTION OF THE EMBODIMENTS

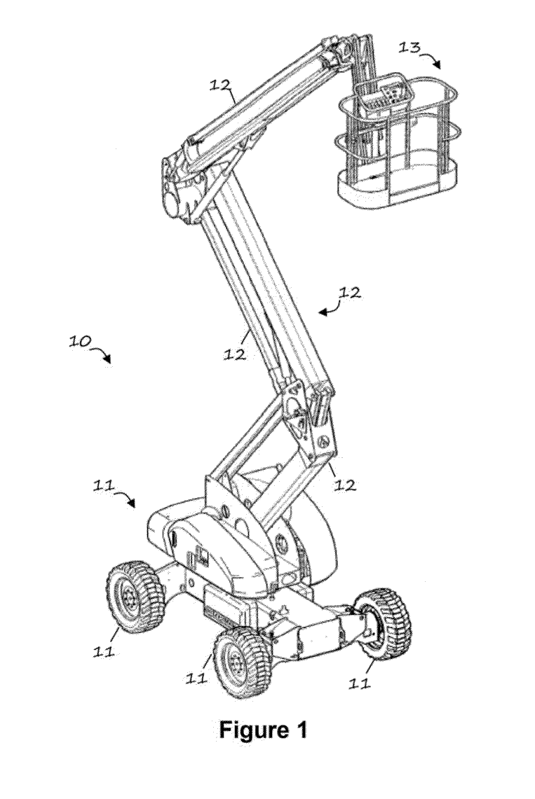

FIG. 1 shows a view of an aerial lift 100. Aerial lifts can come in a variety of shapes and sizes and can be designed for different functions or uses. Known types of aerial lift are, for example, boom lifts, scissor lifts, vehicle (e.g. truck)-mounted lifts, tracked lifts (i.e. having caterpillar tracks), spider lifts (e.g. having spreading supports such that the lift base is immobile in use), personnel lifts, etc. All these types of aerial lift are intended to be within the scope of the present invention.

Aerial lift 100 comprises a base 110 comprising wheels 112, a powered drive system 114 (not shown in FIG. 1) for driving and steering the wheels, and a powered hydraulic system 116 (not shown in FIG. 1) for manipulating a boom 120. Boom 120 is rotatably mounted to base 110 and comprises articulated sections 122, 124 and 126 that allow the boom to be raised and lowered and which can allow some forward and backward and other movement. Other arrangements of boom 120 can be provided to enable a range of different movements. For example, telescopic sections may be provided to allow the boom to extend up and down and to be moved forwards, backwards and sideways relative to a base.

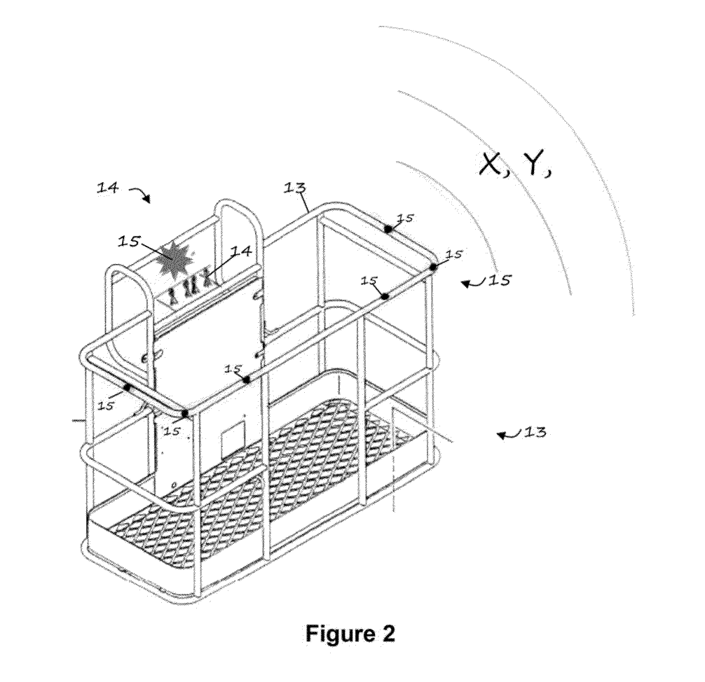

A platform 130, for supporting operators, equipment, and other payloads, is connected to the distal end of boom section 126 and is arranged to be stabilised such that the platform 130 is kept level. A detail view of the basket is shown in FIG. 2.

Referring to FIG. 2, a control panel 140 is provided on the platform 130 at one side of the platform at waist level of an operator (not shown in FIG. 2). The control panel comprises a plurality of control sticks 141a, 141b, 141c, 141d and buttons (not shown in FIG. 2) coupled to and a control module 142 (not shown in FIG. 2) positioned underneath the control panel and operable to cause the control module to send control signals to the powered drive system 114 and the powered hydraulic system 116 in the base 110, to allow the operator to effect the movement of the base and boom across its full range, to manoeuvre the platform 140 to a desired position to carry out work.

A protective rail 132 is provided, for example at waist height, surrounding the perimeter of the platform 130 to prevent the operator from falling from the platform. Further bars or netting may be provided between the protective rail 132 and the platform 130 such that the platform 130 and rail 132 are commonly referred to together as a ‘basket’ or ‘cage’. The protective rail 132 does not obstruct access to the control panel 140.

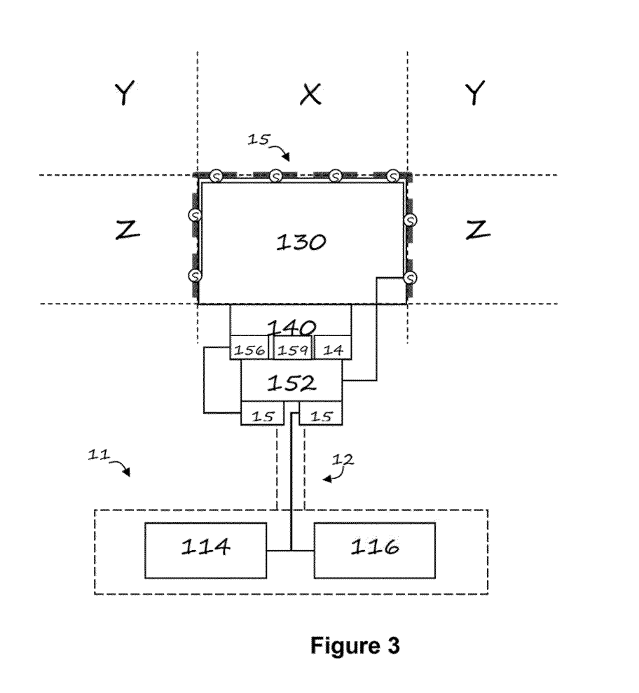

The platform is provided with proximity sensing means 150 arranged to, in use, remotely sense the presence of off-platform objects within a sensing zone (indicated by regions X, Y, Z) opposite the control panel. Referring to FIG. 3, the regions of the sensing zone can be seen from above. In this embodiment, the proximity sensing means 150 is configured to remotely sense the presence of off-platform objects within a sensing zone X opposite the control panel. In this embodiment, however, the proximity sensing means 150 is also configured to remotely sense the presence of off-platform objects within sensing zones Z to the sides of the control panel and sensing zones Y between the zones X and Z. Therefore, the proximity sensing means 150 in accordance with the present invention can provide only the X sensing zone, or it can provide the X and Z, or X and Y or X, Y and Z sensing zones. The proximity sensing means 150 is arranged such that objects within the perimeter of the platform 130 are substantially not sensed.

The nominal range of the proximity sensing means 150 (i.e. the extent of the sing zones from the platform) in this embodiment is 5 meters from the platform in each of the sensing zones X, Y and Z. Alternatively, the nominal range may be another distance, such as 3m or 2m. This nominal range may be adjustable to suit the aerial lift or the working environment. Alternatively, the nominal range of each sensing zones X, Y, Z may be different.

The proximity sensing means 150 may comprise one or more types of device or devices usable individually or together to remotely sense whether or not an off-surface object is present within the nominal range of sensing zone. In this embodiment, the proximity sensing means 150 comprises a plurality of proximity sensors 151 (indicated by the letter ‘S’ in FIG. 3) supported by the protective rail 132. The proximity sensors are preferably passive infrared sensors of a heavy-duty type such as those used in the aerospace industry, or ultrasonic sensors. Alternatively, or in addition, the proximity sensing means may include remote sensing rangefinders, optoelectronic devices, ultrasonic probes, etc.

In this embodiment, the proximity sensors 151 are arranged around the protective rail 132 surrounding the platform so as to create sensing zones X, Y and Z. Alternative arrangements of the proximity sensors 151 to only provide sensing zones X, X and Y, or X and Z are intended to be within the scope of the invention.

In this embodiment the proximity sensors 151 are integrated into the rail 132 at the time of manufacture. In alternative embodiments (not shown in the Figures), the proximity sensors 151 are provided on one or more members mounted to the protective rail 132. In these alternative embodiments, the proximity sensors 151 and one or more members may have been assembled from a kit of parts retrofitted to the aerial lift. The members may be configured to be mountable to the platform 130 or protective rail 132 according to the specific design of the aerial lift 100 to provide the correct arrangement of sensors to, in use, provide the desired sensing zone.

Referring now to FIG. 3, the proximity sensing means 150 is indicated by a thick dashed line around the perimeter of the platform 130 opposite and to the sides of the control panel 140 incorporating control module 142. The proximity sensors ‘S’ are connected together by a wired connection to a proximity sensor control module 152 fitted behind the control panel. Alternatively, wireless coupling between the proximity sensors ‘S’ and the proximity sensor control module 152 could be used. The proximity sensor control module 152 may have been fitted at the time of manufacture of aerial lift 100, or it may have been retrofitted to aerial lift 100 as part of a kit of parts for providing the safety device of the invention.

The proximity sensors ‘S’ send proximity signals to proximity sensor control module 152 indicative of whether or not they individually or collectively remotely sense the presence of an off-surface object within the nominal range of sensing zones X, Y, Z. The proximity sensor control module 152 processes the proximity signals to determine whether or not the proximity sensing means is remotely sensing the presence of an off-surface object within the nominal range of sensing zones X, Y, Z. The object could represent a potential collision hazard.

The proximity sensor control module 152 is coupled to and/or comprises:
alarm means 154 coupled to and configured to signal an auditory and/or visual alarm 156 responsive to the sensing of the presence of an object within the sensing zone by the proximity sensors ‘S’;
shut-down means 158 coupled to the powered drive system 114 and the powered hydraulic system 116 (directly or via a safety circuit in control module 142) and configured to stop further movement of the platform 130 responsive to the sensing of the presence of an object within the sensing zone by the proximity sensors ‘S’; and
override means 159 (in this instance provided on and operable from the control panel 140) operable by an operator to deactivate the alarm means 154 and/or the shut-down means 158 and/or the proximity sensing means 150, for example, if the operator is aware of an object in the sensing zone X, Y, Z and wishes to continue manoeuvring the platform 130 without interruption from the safety device.

However, in other embodiments, the proximity sensor control module 152 may be connected only to the alarm means 154, whereas the shut-down means 158 and override means 159 are omitted such that the safety device is communicatively isolated from the control system of the aerial lift and is not configured to automatically deactivate the movement of the platform on detection of an object in a sensing zone.

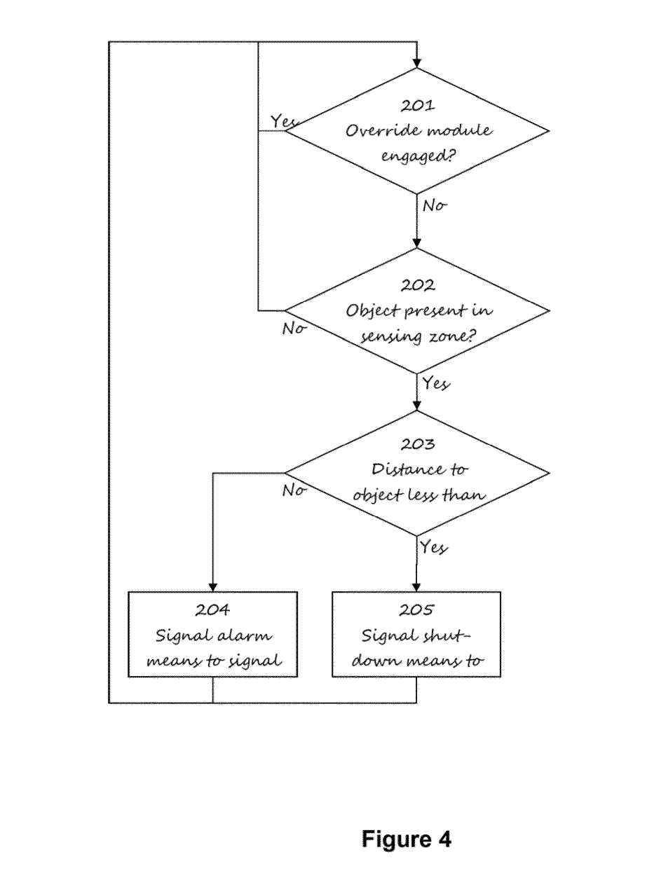

A method, which may for example be carried out by an appropriately configured logic controller in proximity sensor control module 152, of operating a safety device for an aerial lift 100 during use of the aerial lift in accordance with the present invention will now be described with reference to the process flow diagram in FIG. 4.

The process begins at step 201 where it is checked whether the operator has engaged the override means 159. if yes, then the process loops back to keep checking until the override means 159 is disengaged.

If no, the process continues to step 202 where it is checked whether or not the proximity sensing means 150 has remotely sensed the presence of an off-platform object within a sensing zone. If no, the process returns to step 201.

If yes, the process continues to step 203 where it is checked whether or not the object present in the sensing zone is closer to the platform 130 than a threshold shut-down distance.

If no, the alarm means 154 is signalled at step 204 to signal an auditory and/or visual alarm 156, and the process cycles back to step 201 where the alarm is maintained until the override means 159 is engaged or the object leaves the sensing zone, or the object comes closer to the platform 130 than the threshold shut-down distance.

If the object comes closer to the platform 130 than the threshold shut-down distance, the shut down means 158 is engaged at step 205 such that the powered drive system 114 and the powered hydraulic system 116 are deactivated to stop further movement of the platform, and the process cycles back to step 201 until the override means 159 is engaged and the powered drive system 114 and the powered hydraulic system 116 are once again activated, allowing the operator to move away from the hazard.

1. A safety device for an aerial lift comprising a moveable platform having a control panel operable to manoeuvre the platform provided near a first side of the platform; the safety device comprising:
proximity sensing means arranged to, in use, remotely sense the presence of off-platform objects within a sensing zone opposite the control panel.

2. A safety device as claimed in claim 1, wherein the sensing zone is arranged to detect the presence of objects located substantially outside the perimeter of the platform.

3. A safety device as claimed in claim 1, wherein the proximity sensing means comprises one or more proximity sensors.

4. A safety device as claimed in claim 3, wherein the one or more proximity sensors are supported by a protective rail surrounding the platform.

5. A safety device as claimed in claim 4, wherein the one or more proximity sensors are arranged around the protective rail on at least a side of platform opposite the control panel.

6. A safety device as claimed in claim 4, wherein the one or more proximity sensors are provided on one or more members mounted to the protective rail.

7. A safety device as claimed in claim 6, wherein the one or more proximity sensors and one or more members are assembled from a kit of parts retrofitted to the aerial lift.

8. A safety device as claimed in claim 4, wherein the one or more proximity sensors is integrated with the protective rail.

9. A safety device as claimed in claim 3, wherein the one or more proximity sensors are passive infrared sensors or ultrasonic sensors.

10. A safety device as claimed in claim 1, further comprising alarm means configured to signal an alarm responsive to the sensing of the presence of an object within the sensing zone by the proximity sensing means.

11. A safety device as claimed in claim 10, wherein the alarm means provides a visual alarm and/or auditory alarm.

12. A safety device as claimed in claim 10, wherein the proximity sensing means and its corresponding alarm means are communicatively isolated from a control system of the aerial lift.

13. A safety device as claimed in claim 10, wherein the proximity sensing means and its corresponding alarm means are communicatively coupled with a control system of the aerial lift.

14. A safety device as claimed in claim 10, further comprising shut-down means configured to stop further movement of the platform responsive to the sensing of the presence of an object within the sensing zone by the proximity sensing means.

15. A safety device as claimed in claim 14, wherein the alarm means is configured to signal an alarm responsive to the sensing the presence of an object by the proximity sensing means at a first distance from the platform in the sensing zone, and wherein the shut-down means is configured to stop further movement of the platform responsive to the sensing of the presence of an object by the proximity sensing means at a second distance from the platform in the sensing zone, wherein the first distance is greater than the second distance.

16. A safety device as claimed in claim 14, further comprising an override means operable to deactivate the alarm means and/or the shut-down means and/or the proximity sensing means.

17. A safety device as claimed in claim 1, wherein the nominal range of the sensing zone is 5 meters from the platform, preferably 3 meters from the platform, more preferably 2 meters from the platform.

18. An aerial lift comprising:
a moveable platform having a control panel operable to manoeuvre the platform provided near a first side of the platform;
a foot switch located adjacent the control panel configured to enable the movement of the platform only when the foot switch is closed; and
a safety device including proximity sensing means arranged to, in use, remotely sense the presence of off-platform objects within a sensing zone opposite the control panel.

19. A method for providing a safety device in an aerial lift comprising a moveable platform having a control panel operable to manoeuvre the platform provided near a first side of the platform, the method comprising:
providing proximity sensing means on the platform and arranging the proximity sensing means to, in use, remotely sense the presence of off-platform objects within a sensing zone opposite the control panel.

20. A method as claimed in claim 19, wherein the proximity sensing means comprises one or more proximity sensors and wherein providing and arranging the proximity sensing means comprises providing the one or more proximity sensors to be supported by the platform and locating the proximity sensors in positions to provide a sensing zone opposite the control panel.

21. A method as claimed in claim 19, wherein the proximity sensing means comprises one or more proximity sensors arranged on one or more members configured to be mounted about a protective rail surrounding the platform and wherein providing and arranging the proximity sensing means comprises mounting the one or more members about the protective rail.

22. A method as claimed in claim 19, wherein the proximity sensing means and its corresponding alarm means are communicatively isolated from a control system of the aerial lift.

23. A method as claimed in claim 19, further comprising installing a proximity sensor control module at the control panel and communicatively coupling the proximity sensor control module to the proximity sensing means.

24. A method as claimed in claim 23, wherein the proximity sensor control module comprises one or more of:
alarm means configured to signal an alarm responsive to the sensing of the presence of an object within the sensing zone by the proximity sensing means;
shut-down means configured to stop further movement of the platform responsive to the sensing of the presence of an object within the sensing zone by the proximity sensing means; and
an override means operable to deactivate the alarm means and/or the shut-down means and/or the proximity sensing means.

25. A method of averting an accident when operating an aerial lift comprising a moveable platform having a control panel operable to manoeuvre the platform provided near a first side of the platform, the method comprising:
remotely sensing whether or not an off-platform object is present in a sensing zone of proximity sensing means arranged to remotely sense the presence of off-platform objects within a sensing zone opposite the control panel; and
if an object is sensed in the sensing zone, signalling an alarm and/or shutting down the aerial lift to stop further movement of the platform.

26. A kit of parts for installing a safety device in an aerial lift, comprising:
one or more proximity sensors; and
one or more members adapted to be mounted to a platform of an aerial lift and to receive and support said one or more proximity sensors such that, in use, the one or more proximity sensors are arranged to remotely sense the presence of off-platform objects within a sensing zone opposite a control panel provided on a moveable platform of the aerial lift.

27. A kit of parts as claimed in claim 26, wherein the proximity sensing means and its corresponding alarm means are configured to be, in use, communicatively isolated from a control panel of the aerial lift.

28. A kit of parts as claimed in claim 26, further comprising a proximity sensor control module configured to be installed in the control panel and to be communicatively coupled in use to the one or more proximity sensors.

29. A kit of parts as claimed in claim 28, wherein the proximity sensor control module comprises one or more of:
alarm means configured to signal an alarm responsive to the sensing of the presence of an object within the sensing zone by the one or more proximity sensors;
shut-down means configured to stop further movement of the platform responsive to the sensing of the presence of an object within the sensing zone by the one or more proximity sensors; and
override means operable to deactivate the alarm means and/or the shut-down means and/or the one or more proximity sensors.
